(19) United States
(12) Patent Application Publication
(10) Pub. No.: US 2018/0031376 A1
(43) Pub. Date: Feb. 1, 2018

(54) SYSTEMS AND METHODS FOR COMPUTING AND DISPLAYING NAVIGATION INDICATORS BASED ON HISTORIC AND REAL-TIME VESSEL DATA

(71) Applicant: ECOLE POLYTECHNIQUE FEDERALE DE LAUSANNE (EPFL), Lausanne (CH)

(72) Inventors: Julien Vincent Pilet, Renens VD (CH); Jonas Olof Martin Östlund, Malmö (SE)

(73) Assignee: ECOLE POLYTECHNIQUE FEDERALE DE LAUSANNE (EPFL), Lausanne (CH)

(21) Appl. No.: 15/550,423

(22) PCT Filed: Feb. 13, 2015
(86) PCT No.: PCT/EP2015/053115

§ 371 Date: Aug. 11, 2017

(51) Int. Cl. G01C 21/20; G06F 17/30

(52) U.S. Cl. CPC G01C 21/203; G06F 17/30241; G06F 17/30371; B63B 2035/009

(57) ABSTRACT

System and methods for computing true wind and true current are described. True wind estimation occurs through automatic calibration of data obtained from data acquisition devices (102, 114, 116, 118, 120). Real-time boat performance information is generated through automatic target speed computation. Maneuvers are found in data obtained from the data acquisition devices (102, 114, 116, 118, 120) and, if properly calibrated, wind just prior to a maneuver should be the same as measured wind just after the maneuver. If the measured wind values are not equal, the sum of the wind difference over all maneuvers is minimized.

### FIELD OF TECHNOLOGY

The present disclosure relates generally to nautical sensors and computer technology and, more particularly, to implementation of sensors and computing technology to improve operation of sailing vessels.

### BACKGROUND

Maximizing efficiency when sailing a boat/vessel is critical to sailing success. Often, true wind is estimated to maximize such efficiency. However, estimating true wind on a sail boat is complicated and has traditionally been computed by hand.

Furthermore, use of short term sensor output, e.g., 10 seconds, to compute true wind has been utilized. When these short term, real time data points from various sensors are combined, error results, often several degrees, in the true wind calculation. Each time true wind is calculated inaccurately, it leads to the subsequent calculation being more in error than the preceding calculation, ultimately resulting in a high error, sometimes around 15 to 20 degrees. Moreover, traditional efficiency maximization efforts fail to utilize true current along with true wind when determining the maximum efficiency of a vessel.

European patent application EP 2,354,798 to Suunto Oy discloses a device and an apparatus for determining wind conditions around a sailboat. The device comprises means for receiving a measured wind angle and wind speed readings from a wind sensor attached to the sailboat and readings of boat heading and boat speed through the water, means for storing wind angle correction data, a computing unit for computing a corrected wind angle reading using the measured wind angle reading, the boat speed reading and the wind angle correction data and for computing a wind direction using the corrected wind angle reading and the boat heading reading, and means for displaying or outputting the wind direction. Such an approach suffers various problems overcome by the present disclosure.

United Kingdom patent application GB 2,171,208 to John James Morven Scarlett discloses the performance of a yacht is monitored by measuring the apparent wind angle and the magnetic heading by suitable means and determining the true wind angle from these measurements. The apparent wind speed and boat speed are also measured by suitable means and these measurements are used to determine the true wind speed. The wind pressure is then determined from the true wind speed and the ambient temperature measured by suitable means. The calculated values for the true wind angle, the boat speed, and the wind pressure are supplied to a processor which determines the maximum boat speed for each of a series of wind angles for various values of the wind pressure. The data resulting from such processing is supplied to a polar plotting device which plots a series of polar graphs of maximum boat speed against wind angle. Again, such an approach suffers various problems overcome by the present disclosure.

### SUMMARY

The present disclosure describes systems and methods for computing and displaying true wind and true current. The disclosed systems and methods allow for true wind and true current to be accurately determined through calibration of data obtained from data acquisition devices/sensors located on a sail boat, and may also be used to improve the accuracy of heading, water speed, apparent wind angle and apparent wind speed. True wind estimation occurs through automatic calibration of data obtained from data acquisition devices. Real-time boat performance information is generated through automatic target speed computation. Maneuvers are found in data obtained from the data acquisition devices and, if properly calibrated, wind just prior to a maneuver should be the same as measured wind just after the maneuver. If the measured wind values are not equal, the sum of the wind difference over all maneuvers is minimized. Fast and complete visualization system of all recorded data may be implemented.

An aspect of the present disclosure relates to a system for collecting and processing data to improve sailing performance of a vessel. The system includes data acquisition devices that capture real-time data, such as wind speed, vessel velocity, vessel heading, and water speed. The system further includes a real-time processor that receives the real-time data from the data acquisition devices and processes the real-time data along with calibration parameters to determine true wind and true current experienced by the vessel. Moreover, the system includes a calibration processor that receives the real-time data from the real-time processor and processes the real-time data to produce historic vessel data correlated with timestamps. The calibration processor also processes the historic vessel data to generate the calibration parameters. Processing of the historic vessel data involves using more historic vessel data each time the calibration parameters are generated. Additionally, the system includes a long-term database that stores the historic vessel data. The amount of historic vessel data stored within the long-term database increases as real-time data is captured by the data acquisition devices.

The real-time processor may also determine vessel performance. The calibration processor may further process the historic vessel data to generate target speed tables. Moreover, the calibration processor may split the historic vessel data into tiles with defined geographical locations and scales. The historic vessel data stored within the long-term database may span more than a calendar day, and may span tracks and boundaries.

Another aspect of the present disclosure relates to a method for collecting and processing data to improve sailing performance of a vessel. The method includes receiving real-time data from data acquisition devices. The real time data includes apparent wind speed, wind angle, and vessel velocity. The method further includes storing the real-time data in a historic database as historic vessel data that is correlated with timestamps. Additionally, the historic vessel data further grows in magnitude as the data acquisition devices gather real-time data. Moreover, the method includes processing the historic vessel data to generate calibration parameters, with each calibration parameter being generated using the historic vessel data gathered prior to generation of the calibration parameter. The method also includes processing the real-time data and the calibration parameters to generate a true wind and a true current experienced by the vessel.

The method may further include processing the historic vessel data to generate speed tables. Additionally, the method may include processing the real-time data and the speed tables to determine vessel performance. Generation of each subsequent calibration parameter may use more historic vessel data than each preceding calibration parameter. The historic vessel data within the historic database may span at least a calendar week. Moreover, the method may include displaying post-navigation data using a zoomable map having tiles specific to geographic locations.

An additional aspect of the present disclosure relates to a device for collecting and processing data to improve sailing performance of a vessel. The device includes a processor that receives real-time data from data acquisition devices and that processes the real-time data along with historic vessel data to generate calibration parameters and target speed tables. The processor further processes the real-time data and the calibration parameters to determine true wind and true current experienced by the vessel. Moreover, the processor processes the real-time data and target speed tables to determine vessel performance. The device additionally includes a memory coupled to the processor. The memory includes a database that stores the historic vessel data, which grows in magnitude as the data acquisition devices gather real-time data. The historic vessel data and the real-time data include apparent wind speed, wind angle, and vessel velocity.

The generation of a subsequent calibration parameter may use more historic vessel data than generation of a preceding calibration parameter. The processor may additionally process the historic vessel data to determine maneuvers. The processor may minimize a sum of wind differences over the maneuvers when measured wind values prior to a maneuvers and after a maneuver are not equal.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference number in different figures indicates similar or identical items or features.

FIG. 1A is a block diagram detailing a system for computing and displaying true wind and true current experienced by a sail boat according to an embodiment of the present disclosure.

FIG. 1B is a block diagram detailing a system for computing and displaying true wind and true current experienced by a sail boat according to an embodiment of the present disclosure.

FIG. 2 is a process flow block diagram detailing a method for computing true wind experienced by a sail boat according to an embodiment of the present disclosure.

FIG. 3 is a process flow block diagram detailing a method for computing true current experienced by a sail boat according to an embodiment of the present disclosure.

FIG. 4 is a block diagram detailing a system within which true wind and true current experienced by a sail boat may be computed according to an embodiment of the present disclosure.

### DETAILED DESCRIPTION

The detailed description set forth herein makes reference to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, references to a singular embodiment may include plural embodiments, and references to more than one component may include a singular embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

The present disclose relates to systems and methods that allow for true wind and true current to be accurately determined through calibration of data obtained from data acquisition devices/sensors located on a sail boat. More specifically, the present disclosure allows for a true wind estimation through automatic calibration, real-time boat performance information through automatic target speed computation, and a fast and complete visualization system of all recorded data.

The present disclosure takes obtained data, finds maneuvers like tacking, jibes, or when the boat turns a buoy, and computes the wind before and after the maneuver. If the calibration is correct, the wind should be the same both before and after the maneuver. If the wind is not the same, then the calibration parameters minimizing the sum of the wind difference, over all the maneuvers, are determined.

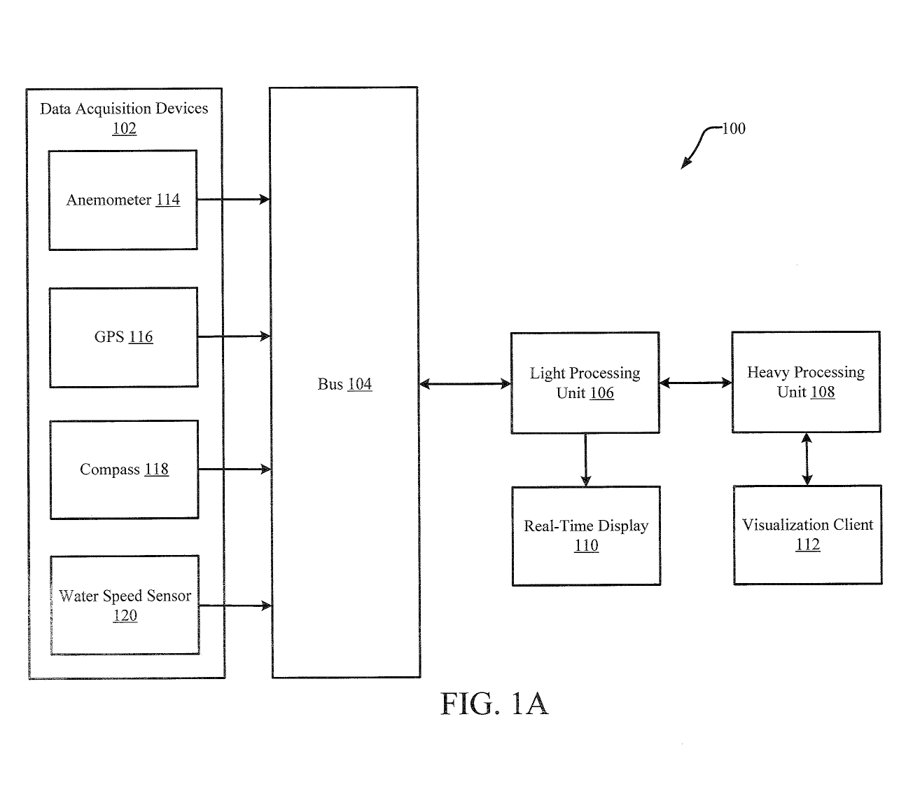

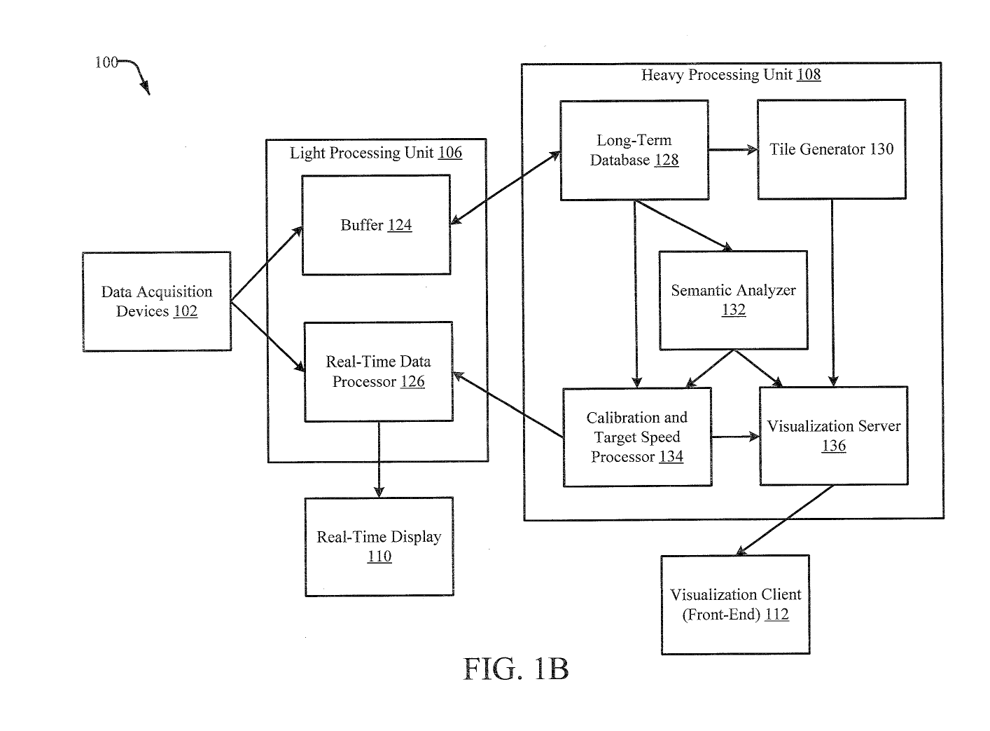

FIGS. 1A and 1B illustrate a system 100 for computing and displaying true wind and true current experienced by a sail boat according to the present disclosure. The system 100 may include data acquisition devices 102, a bus 104, a light (or first) processing unit 106, a heavy (or second) processing unit 108, and various display devices, such as a real-time display 110 and a visualization client 112. It should be appreciated that the “light” and “heavy” processors, while described as separate processors performing discrete functions, could be implemented as a single processor, or some other number of processors different from the illustrative embodiments described herein.

As illustrated in FIG. 1A, the data acquisition devices 102 are transducers/sensors on or proximate to the sail boat that gather various real-time data. The data acquisition devices 102 may include, for example, an anemometer 114 (i.e., wind speed sensor), a global positioning system (“GPS”) 116, a compass 118, and a water speed sensor 120. The anemometer 114 may be a cup anemometer, windmill anemometer, or ultrasonic anemometer, for example. The compass 118 may be a magnetic compass, gyro compass, astrocompass, solid state compass, GPS compass, base plate compass, card compass, thumb compass, or prismatic compass, for example. The data gathered by the data acquisition devices 102 may be concentrated into a single interface, such as, for example, National Marine Electronics Association (“NMEA”) 0183 or NMEA 2000, which are plug-and-play communications standards used for connecting marine sensors and display units within ships and boats. The data acquisition devices 102 are configured to transmit acquired data to the light processing unit 106 over the bus 104.

The light processing unit 106 may be a microcontroller containing a processor core, memory, and programmable input/output peripherals. Referring now to FIG. 1B, the light processing unit 106 may contain a buffer 124 and a real-time data processor 126. The acquired data from the data acquisition devices 102 is stored in the buffer 124, which may be any storage capable of storing data for a temporary amount of time, such as, for example, a USB stick, SD card, or built-in-flash storage. When enough data has been collected by the light processing unit 106 and when a connection to the heavy processing unit 108 is established, the data stored in the buffer 124 is sent to the heavy processing unit 108, specifically to a long-term database 128.

The heavy processing unit 108 may include the long-term database 128, a tile generator 130, a semantic analyzer 132, a calibration and target speed processor 134, and a visualization server 136. The long-term database 128 may contain long-term/historical data captured/acquired by the data acquisition devices 102. The historical data may span a variety of time frames including hours, days, months, and so on, for example. Moreover, the historical data may be a sampling of different weather conditions, thereby allowing for an accurate calibration of a variety of wind ranges. As more and more real-time data is gathered by the data acquisition devices 102 and stored within the long-term database 128 as historic data, the historic data contained within the long-term database 128 increases in magnitude. The data stored in the long-term database 128 may be stored as NMEA sentences in text files, which may be grouped into tuples, also referred to as “nays”. Each nay is specific to a timestamp and thereby groups together values at that timestamp acquired by various data acquisition devices 102. These nays may be ordered according to their timestamps within the long-term database 128.

Both of the processing units 106, 108 may be installed onboard the sail boat. In this instance, the processing units 106, 108 may communicate, for example, via a network cable. However, it should be appreciated that it is possible for the heavy processing unit 108 to not be installed onboard the sail boat. For instance, the heavy processing unit 108 may be located ashore in, for example, a datacenter. In this instance, the light processing unit 106 and the heavy processing unit 108 may communicate through a variety of means. For example, they may communicate via the Internet over a mobile network, with a GSM/3G/4G receiver/transmitter being located at the light processing unit 106. Also, the processing units 106, 108 may communicate via the Internet over a satellite network, with a satellite modem being located at the light processing unit 106. Further, communication may occur via the Internet over WiFi, with an antenna being in communication with the light processing unit 106 and an access point being in communication with the heavy processing unit 108. Moreover, they may communicate using a mobile phone that shares its Internet connection through Bluetooth, WiFi, or any other local communication means, for example.

During pertinent sailing experiences, e.g. race after race, data accumulates within the long-term database 128. When a high magnitude of historical data is involved, it is difficult to load the data in a single webpage to visualize everything. To navigate through the potentially large amount of data, the data may be pre-processed for visualization by the tile generator 130. The tile generator 130 simplifies the data, producing a simplified curve that, when zoomed, data may be captured in geographic blocks within the webpage. Accordingly, the tile generator 130 may split the data into “tiles” with a defined geographical location and scale. Generating the tiles may include segmenting all nay samples into tracks and creating a boundary when one (1) minute transpires without any data accumulation. All nays may be annotated with corrected measures and boat performance. For each nay and for each tile it covers, the track may be clipped to the tile and approximated with a fixed number of points, e.g., 32, using, for example, Visvalingam's algorithm for line simplification. Moreover, the clipped and simplified segment may be added to a database of segments (not illustrated), with boatID, tile coordinates, and scale as keys.

The semantic analyzer 132 generates a parse tree from a sequence of nays. The parse tree allows for the searching of particular events in the data or the building of a browsable overview of the data. Given a discrete set L of labels, the semantic analyzer 132 may assign a label from the set to every nay in a sequence of N nays, sorted by their timestamp. For instance, a set of such labels may be L₀={Downwind, Upwind} to denote if the boat, for a particular nay, is sailing downwind or upwind. The set of labels together with the rule to assign those labels to each nay in a sequence is also referred to as “grammar”.

The assignment of labels to nays in a sequence is the solution of an optimization problem where an objective function ƒ: L^{N}→R is minimized with respect to a vector of states. The objective function may have the form of Equation 1 below.

$$f ( I ) = {\sum }_{n = 1}^{N} {C}_{state} ( n , {I}_{n} ) + {\sum }_{i = 1}^{N - 1} {C}_{transition} ( n , {I}_{n} , {I}_{n + 1} ) \qquad Equation 1$$

wherein:
Cₛₜₐₜₑ is defined by the grammar from the sequence of nays and is the cost of assigning label Iₙ to the nay with index n; and
Cₜᵣₐₙₛᵢₜᵢₒₙ is defined by the grammar from the sequence of nays and is the cost of jointly assigning label Iₙ to a nay with index n and label Iₙ₊₁ to nay with index n+1.
This optimization problem has a structure equivalent to a hidden markov model (“HMM”).

The Cstate(n, In) cost term may be decoupled into two terms as Cstate(n, In)=Cmatch(n, In)+Cstatic(In). The apparent wind angle (“AWA”) of a nay with index n is mapped to an integer G, such as 0, 1, 2, 3, 4 or 5, for example. Assuming 0°≦AWA<360°, it is true that 60°×G≦AWA<60°×(G+1). Furthermore, In is mapped to an integer H, also one of the six integer 0, 1, 2, 3, 4 or 5, so that H is the remainder of the integer division (In −1)/6. A matching cost E is defined so that E=0 if G=H, otherwise E=1.

Once H has been computed, the value of Cstatic(In) is defined. For state indices In whose corresponding label contains the substring “before-race”, Cstatic evaluates to 0 if H=1 or H=4, otherwise Cstatic evaluates to ¼. For state indices In whose corresponding label contains the substring “upwind-leg”, Cstatic evaluates to 0 if H=0 or H=5, otherwise Cstatic evaluates to ¼. For state indices In whose corresponding label contains the substring “downwind-leg”, Cstatic evaluates to 0 if H=2 or H=3, otherwise Cstatic evaluates to ¼. For state indices In whose corresponding label contains the substring “idle”, Cstatic always evaluates to ⅙. For state index In=25, Cstatic evaluates to 1. The cost. Cmatch(n, In) is 0 if G=H, otherwise, it equals 1.

The Ctransition(n, In, In+1) may be decomposed as Ctransition(n, In, In+1)=Cmajor(In, In+1)+Cminor(In, In+1)+Conoff(In, In+1)+Ctime(n, In, In+1). The cost Conoff(In, In+1) is defined as follows: if exactly one of In and In+1 is 25, then Conoff evalutes to 32. Otherwise, it evaluates to 0. To define the cost Cmajor, indices to Jn=floor((In −1)/6) and Jn+1=floor((In+1−1)/6) are first computed, wherein the floor(x) function is the integer part of a positive fractional number x. The cost Cmajor(In, In+1) may then be defined as follows: if Jn=Jn+1 or if at least In=25 or In+1=25, then Cmajor evalutes to 0. If (Jn, Jn+1) is one of (0, 1), (0, 2), (1, 2), (2, 1), (1, 3), (2, 3) or (3, 0), then Cmajor evaluates to 16. In all other cases, Cmajor evaluates to infinity. The cost Cminor(In, In+1) is 0 if at least one of In and In+1 is 25. Otherwise, it is the remainder of the integer division |In−In+1|/6. The cost Ctime(n, In, In+1) evaluates to 0 if at least In=25 or In+1-25. Otherwise, it evalutes to 0.01T, where T is the absolute time difference in seconds between the time of nav with index n and nav with index n+1.

The grammar for wind-oriented races may assign the following labels to the nays:

1. Top/Sailing/Not in race/before-race/starboard-tack/close-hauled

2. Top/Sailing/Not in race/before-race/starboard-tack/beam-reach

3. Top/Sailing/Not in race/before-race/starboard-tack/broad-reach

4. Top/Sailing/Not in race/before-race/port-tack/broad reach

5. Top/Sailing/Not in race/before-race/port-tack/beam-reach

6. Top/Sailing/Not in race/before-race/port-tack/close-hauled

7. Top/Sailing/In race/upwind-leg/starboard-tack/close-hauled

8. Top/Sailing/In race/upwind-leg/starboard-tack/beam-reach

9. Top/Sailing/In race/upwind-leg/starboard-tack/broad-reach

10. Top/Sailing/In race/upwind-leg/port-tack/broad-reach

11. Top/Sailing/In race/upwind-leg/port-tack/beam-reach

12. Top/Sailing/In race/upwind-leg/port-tack/close-hauled

13. Top/Sailing/In race/downwind-leg/starboard-tack/close-hauled

14. Top/Sailing/In race/downwind-leg/starboard-tack/beam-reach

15. Top/Sailing/In race/downwind-leg/starboard-tack/broad-reach

16. Top/Sailing/In race/downwind-leg/port-tack/broad-reach

17. Top/Sailing/In race/downwind-leg/port-tack/beam-reach

18. Top/Sailing/In race/downwind-leg/port-tack/close-hauled

19. Top/Sailing/Not in race/idle/starboard-tack/close-hauled

20. Top/Sailing/Not in race/idle/starboard-tack/beam-reach

21. Top/Sailing/Not in race/idle/starboard-tack/broad-reach

22. Top/Sailing/Not in race/idle/port-tack/broad-reach

23. Top/Sailing/Not in race/idle/port-tack/beam-reach

24. Top/Sailing/Not in race/idle/port-tack/close-hauled

25. Top/Off

The calibration and target speed processor 134 computes parameters that determine how the raw data measurements from the data acquisition devices 102 are mapped to values that represent true quantities being measured by the data acquisition devices 102. From these true quantities, the calibration and target speed processor 134 may estimate true wind and true current 2D vectors in a local coordinate system tangent to the sea surface. As illustrated above, as more and more data is gathered by the data acquisition devices 102 and stored within the long-term database 128 as historic data, the historic data contained within the long-term database 128 increases in magnitude. Thus, each time the calibration and target speed processor 134 computes calibration parameters, the calibration includes more and more historic data, thereby increasing the accuracy of the parameters computed.

A maneuver is a rapid transition from one sail trim and boat course to a different sail trim and course. The semantic segmentation generated by the semantic analyzer 132 above allows for maneuvers to be identified by looking for transitions from upwind-leg to downwind-leg, starboard-tack to port-tack, and vice versa, for example.

For properly calibrated instruments, and assuming locally constant wind and current, there is no difference in estimated true wind and true current just prior to a maneuver and just after a maneuver. Thus, letting X in the set R′″ (R denotes the set of real numbers and R′″ is the m-dimensional space of real numbers) be a vector of m parameters to calibrate, an unconstrained optimization problem may be formulated where an objective function is minimized. This may be illustrated by Equation 2 below.

$$f ( x ) = {\sum }_{i = 1}^{M} α {‖ W ( {p}_{i} , X ) - W ( {s}_{i} , X ) ‖}^{2} + β {‖ C ( ( {p}_{i} , X ) - C ( {s}_{i} , X ) ) ‖}^{2} \qquad Equation 2$$

wherein:
M is a number of maneuvers;
W: R×R^{m}→R² is a function mapping a time and calibration parameters to an estimated true wind vector; and
C: R×R→R² is a function mapping a time and calibration parameters to an estimated true current vector.

These vectors may be computed as local averages in time to reduce the effect of noise. The times pᵢ, sᵢ and R are times just before and just after maneuvers, respectively. The values α, β and R are weights to balance the calibration. Optimization may be achieved with the Levenberg-Marquardt, damped least-squares method. The X vector consists of the following parameters, which may be repeated for various apparent wind angle (“AWA”), for example a subset of X is used for 0<AWA<90, another for 90<AWA<180, another for −90<AWA<0, and a last for −180<AWA<−90:
Magnetic offset Qₘ related to block 206 and explained in paragraph [0043];
Angle offset Q_{w} related to block 212 and explained in paragraph [0044];
Wind speed correction parameters k_{w} and m_{w} related to block 222 and explained in paragraph [0046];
Leeway model parameters p and q related to block 302 and explained in paragraph [0048]; and
Water speed correction parameters k_{c} and m_{c} related to block 308 and explained in paragraph [0048],

Upon completing the above calibration, the calibration and target speed processor 134 may estimate the target speed of the sail boat, which amounts to estimating the maximum speed that the boat may reach under given stable wind conditions and a given stable course of the boat. Two types of target speeds exist: wind oriented and pure speed.

For wind oriented, which is associated with wind oriented regattas, it may be desirable to maximize the sail boat speed vector projected on the wind vector when the boat is either sailing upwind or downwind. This is also known as Velocity Made Good (“VMG”). VMG may be calculated from true wind speed (“TWS”) when the boat is sailing upwind and from past/historical measurements when the boat is sailing downwind. Given a set of nays of past measurements, pairs of (TWS, VMG) are obtained when the boat is either sailing upwind or downwind. The VMG values may be grouped into bins distributed over a range of TWS values. Each such bin may be the set of VMG values for which the TWS values belong to an interval of |γ,δ|. The target speed for a bin may be defined as the VMG value at, for example, the 80th percentile of the values within the bin. Defining the target speed a bin may further include sorting the VMG values of the bin prior to determining the target speed.

Pure speed is associated with general regattas. Given a set of nays, a set of 3D vectors of values (TWA, TWS, TS) are built, wherein TWA denotes a true wind angle and TS denotes the target speed that is set to the measured water speed of the boat. A probability density function from this set of vectors is estimated using a Gaussian kernel at each point with a suitable bandwidth parameter. This may result in a probability density function (“PDF”) R³→|0, 1| mapping an arbitrary point to a probability density. A target speed function may be estimated that maps TWA and TWS to a target speed. This function may be obtained by sampling values of TWA for angles between 0 and 360 degrees and TWS within a reasonable range. For example, a sailor may not be interested in knowing the performance of the boat beyond 25 m/s of wind strength because such conditions are unusual. Thus, a reasonable range of TWS according to this may be 0 to 25 m/s.

For fixed values of TWA and TWS, a cumulative density function (“CDF”) is estimated along the TS dimension, which is indicated by Equation 3 below.

cdf(TWA,TWS,TS)=∫_{-∞}^{TS}pdf(TWA,TWS,x)dx Equation 3

The estimated target speed function may be indicated by the following Equation 4.

$$EST - TS ( TWA , TWS ) = arg {min}_{x} \vert \frac{cdf ( TWA , TWS , x )}{cdf ( TWA , TWS , ∞ )} - 0.8 \vert \qquad Equation 4$$

This function is evaluated for all discrete pairs of sampled TWA and TWS values. For the remaining values in between, bilinear interpolation may be utilized.

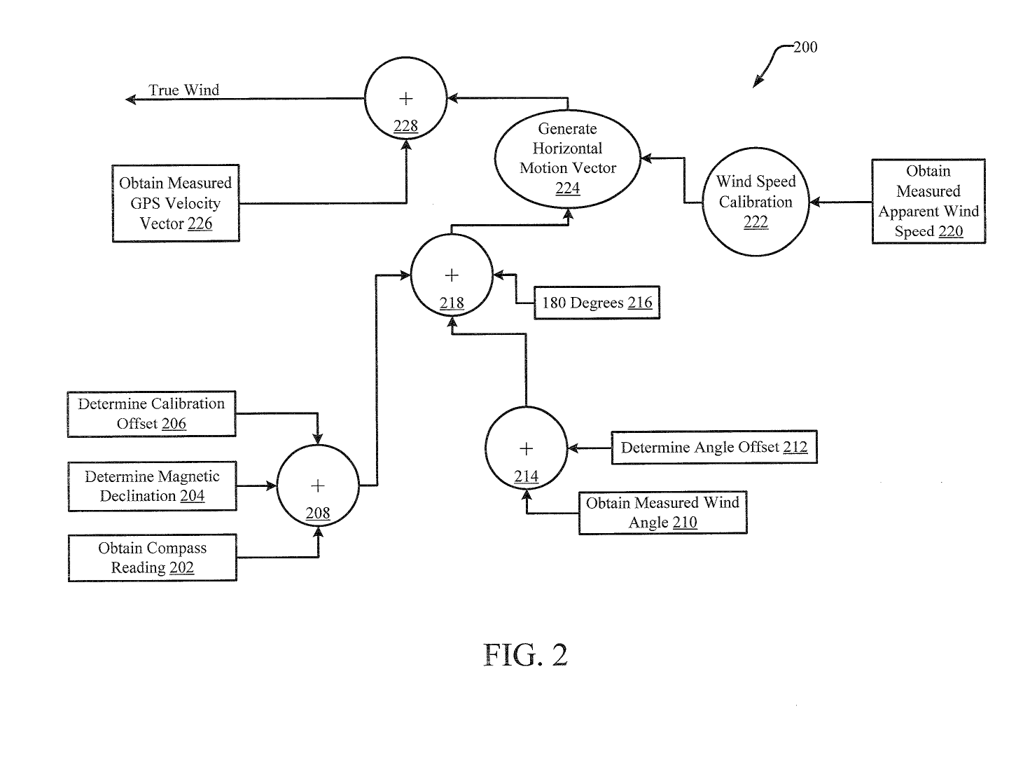

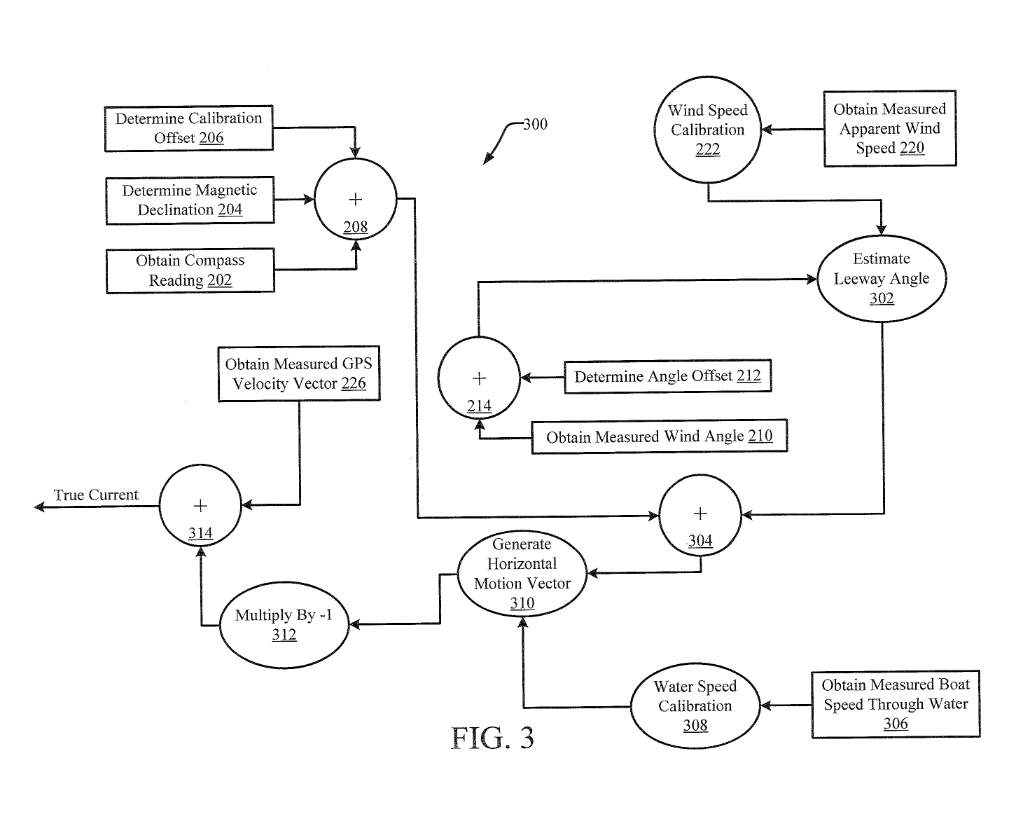

The real-time data processor 126 of the light processing unit 106 processes data to compute information that may be visualized in real-time by a sailor. The real-time data processor 126 receives real-time data output from the data acquisition devices 102, and exploits the calibration parameters and target speed tables received from the calibration and target speed processor 134, to compute, in real-time, true wind and true current according to the calibration parameters (described in detail with reference to FIGS. 2-3 below). The real-time data processor 134 may thereby produce the following computed or calibration-corrected measurements: apparent wind angle (“AWA”); apparent wind speed (“AWS”); true wind angle (“TWA”), which is the angle between the boat and the wind; true wind speed (“TWS”); true wind direction (“TWD”), which is the angle between the geographic north and the wind; water speed, heading, water current direction, water current speed, and leeway angle. These measurements may then be sent from the real-time data processor 126 to the real-time display 110. The real-time display 110 may be any display capable of displaying content in real-time such as, for example, a phone, tablet, computer, a smart watch, or screen independent from a core processor.

The real-time data processor 126 may also determine boat performance according to the target speed tables received from the calibration and target speed processor 134. There are two potential boat performance modes: wind oriented, i.e., race mode, and normal mode. Wind oriented mode assumes the goal is either to sail upwind or downwind. Performance may be evaluated on how fast the boat is climbing up or sliding down the wind. Boat speed in a direction perpendicular to the wind does not influence the performance evaluation in wind oriented mode. To compute boat performance in wind oriented mode, the real-time data processor 126 determines whether the boat is currently sailing upwind or downwind. This may be achieved by thresholding TWA at +90 and −90 degrees. An upwind or downwind target VMG table may be looked up using TWS as a key. This lookup provides a target VMG. The current VMG is computed by projecting the boat water motion vector on the wind axis and the performance indicator is the ratio between the current VMG and the target VMG.

For pure speed mode, i.e., when the boat has to reach a destination that may be sailed to directly without any tack or jibe, the speed over water is used instead of VMG. To compute the performance percentage, a target speed may be obtained by looking up the boat speed table using TWA and TWS. The performance percentage is defined as the water speed divided by the target speed.

Post-navigation data visualization may be displayed on the visualization client 112. This is achieved using, for example, a web interface that shows a map and a list of races. The map may be displayed using tiles generated by the tile generator 130. Rendered image tiles may be used for the background and may be provided by OpenStreetMap. Boat trajectories may be displayed with a vector tile overlay.

FIG. 2 illustrates a method 200 for computing true wind experienced by a sail boat according to the present disclosure. The method 200 may be performed by one or more processors such as, for example, the real-time data processor 126 and the calibration and target speed processor 134 described in detail above with respect to FIGS. 1A and 1B. At block 202 a compass reading is obtained. At block 204 the magnetic declination of the compass reading is determined. Magnetic declination is the difference between magnetic North and geographic North. At block 206 a calibration offset Qₘ is determined. At calculation point 208 the boat's orientation with respect to Earth is calculated/estimated by adding the calibration offset (illustrated as block 206) to the compass reading (illustrated as block 202) and, if available, the magnetic declination (illustrated as block 204).

At block 210 a measured wind angle may be obtained from an anemometer and at block 212 an angle offset Q_{w}, which is obtained as one of the m components in the X vector that minimizes the function of Equation 2, is determined. At calculation point 214 a corrected apparent wind angle with respect to boat orientation is calculated by adding the measured wind angle of block 210 to the angle offset Q_{w} of block 212.

At calculation point 218 the angle of the apparent wind with respect to Earth is calculated using the boat orientation with respect to Earth (illustrated as calculation point 208), the corrected apparent wind angle with respect to the boat orientation (illustrated as calculation point 214), and by adding 180 degrees (illustrated as block 216). Adding the 180 degrees (illustrated as block 216) ensures the vector points in the direction the wind is blowing, instead of where it is coming from.

At block 220 the measured apparent wind speed (“AWS”) is obtained. Apparent wind is the wind experienced by a sailor in motion, and is the relative velocity of the wind in relation to the sailor. At circle 222 wind speed calibration transpires. This may include correcting the measured apparent wind speed by applying the function f(x)=k_{w}*x+m_{w} to it, with k_{w} and m_{w} being parameters of the X vector in Equation 2. At oval 224 a horizontal motion vector is generated. At block 226 a measured GPS velocity vector is obtained. At calculation point 228 an apparent wind velocity vector is calculated by adding the GPS velocity vector of block 226 to the vector of block 224.

FIG. 3 illustrates a method 300 for computing true current experienced by a sail boat according to the present disclosure. The method 300 may be performed by one or more processors such as, for example, the real-time data processor 126 and the calibration and target speed processor 134 described in detail above with respect to FIGS. 1A and 1B. At block 220 the measured apparent wind speed (“AWS”) is obtained. Apparent wind is the wind experienced by a sailor in motion, and is the relative velocity of the wind in relation to the sailor. At circle 222 wind speed calibration transpires. This may include correcting the measured apparent wind speed by applying the function f(x)=k_{w}*x+m_{w} to it, with k_{w} and m_{w} being parameters of the X vector in Equation 2. At block 210 a measured wind angle may be obtained from an anemometer and at block 212 an angle offset, which is obtained as one of them components in the X vector that minimizes the function of Equation 2, is determined. At calculation point 214 a corrected apparent wind angle with respect to boat orientation is calculated by adding the offset of block 212 to the measured apparent wind angle of block 210. At oval 302 a leeway angle is estimated using the apparent wind speed (AWS) and apparent wind angle (AWA). Leeway is the amount of drift motion to leeward of a boat in the water and may be estimated using Equation 5 below,

$$f ( AWA , AWS ) = \{ \begin{matrix}p * sin ( 2 * AWA ) * exp ( q * AWS ) when cos ( AWA ) \geq 0 \\ 0 otherwise\end{matrix} \} \qquad Equation 5$$

At block 202 a compass reading is obtained. At block 204 the magnetic declination of the compass reading is determined. Magnetic declination is the angle on the horizontal plane between magnetic north and geographic north. At block 206 a calibration offset, which is obtained as one of the components in the X vector that minimizes Equation 2, is determined. At calculation point 208 the boat's orientation with respect to Earth is calculated/estimated by adding a calibration offset (illustrated as block 206) to the compass reading (illustrated as block 202) and, if available, the magnetic declination (illustrated as block 204). At calculation point 304 an angle of boat motion with respect to the water is calculated using an angle correction determined at oval 302.

At block 306 the measured boat speed through the water is obtained. At oval 308 a water speed calibration occurs. This may include applying the function h(x)=k_{c}*x+m_{c} to the raw water speed measurement, wherein k_{c} and m_{c} are optimized parameters of the X vector in Equation 2. At oval 310 a horizontal motion vector is generated. At oval 312 the horizontal motion vector is multiplied by −1. At block 226 a measured GPS velocity vector is obtained. At calculation point 314 the GPS velocity vector of block 226 is added to the velocity vector of block 312.

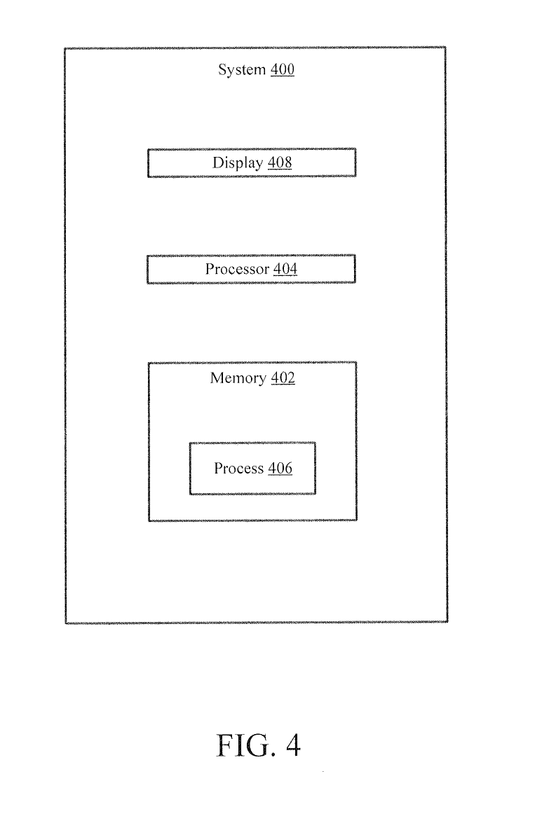

FIG. 4 illustrates a system 400 within which true wind and true current experienced by a sail boat may be computed according to the present disclosure. A memory 402 includes instructions to configure a processor 404 to implement one or more aspects of the methods, steps, and functions disclosed herein (collectively, shown as process 406 in FIG. 4). Different method steps may be performed by different processors. The memory 402 may be distributed or local and the processor 404 may be distributed or singular. The memory 402 may be implemented as an electrical, magnetic or optical memory, or any combination of these or other types of storage devices. It should be noted that if distributed processors are employed, each distributed processor that makes up the processor 404 generally contains its own addressable memory space. A display 408 is representative of a variety of possible input/output devices such as known touch screen displays or the like.

The computer systems and servers described herein each contain a memory that will configure associated processors to implement methods, steps, and functions described. Such methods, steps, and functions may be carried out, e.g., by processing capability on various system elements or by any combination of elements. The memories may be distributed or local and the processors may be distributed or singular. The memories may be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor may retrieve the information from the network.

Accordingly, it will be appreciated that one or more aspects of a system may include a computer program (e.g. process 406) comprising computer program code means adapted to perform one or more steps described when such program is run on a computer, and that such program may be embodied on a tangible computer readable recordable storage medium; for example, in the form of distinct software modules which then execute on one or more hardware processors. Further, a system may include a computer comprising code adapted to cause the computer to carry out one or more steps, together with one or more apparatus elements or features.

Computers discussed herein may be interconnected, for example, by one or more of a network, another virtual private network (VPN), the Internet, a local area and/or wide area network (LAN and/or WAN), via an EDI layer, and so on. The computers may be programmed, for example, in compiled, interpreted, object-oriented, assembly, and/or machine languages, for example, one or more of C, C++, Java, Visual Basic, and the like (a non-limiting list), and may also make use of, for example, Extensible Markup Language (XML), known application programs such as relational database applications, spreadsheets, and the like. The computers may be programmed to implement the methods, steps and logic described.

As described herein a network may include any cloud, cloud computing system or electronic communications system or method which incorporates hardware and/or software components. Communication among the processors may be accomplished through any suitable communication channels, such as, for example, a telephone network, an extranet, an intranet, Internet, point of interaction device (personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse, combinations thereof and/or any suitable communication or data input modality.

As those skilled in the art will appreciate, the consumer may use a computer in the method described and the user computer may include an operating system (e.g., Windows NT, Windows 95/98/2000, Windows XP, Windows Vista, Windows 7, OS2, UNIX, Linux, Solaris, MacOS, etc.) as well as various conventional support software and drivers typically associated with computers.

Any computer system disclosed herein may include a main memory, such as for example random access memory (RAM), and may also include a secondary memory or a removable storage unit. Removable storage unit represents a floppy disk, magnetic tape, optical disk, etc. which is read by and written to by a removable storage drive. As will be appreciated, the removable storage unit includes a computer usable storage medium having stored therein computer software and/or data.

Computer programs implementing the functionality described (also referred to as computer control logic) may be stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, the control logic may be implemented in hardware components such as application specific integrated circuits (ASICs). Implementation of a hardware state machine to perform the functions described herein will be apparent to persons skilled in the relevant art(s).

Databases discussed herein may include relational, hierarchical, graphical, or object-oriented structure and/or other database configurations. Moreover, the databases may be organized in any suitable manner, for example, as data tables or lookup tables. Each record may be a single file, a series of files, a linked series of data fields or other data structure. Association of certain data may be accomplished through any of various desired data association techniques such as those known or practiced in the art.

The computers discussed herein may provide a suitable website or other Internet-based graphical user interface which is accessible by users.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, may be implemented by computer program instructions, loaded onto a programmable data processing apparatus to produce a machine, such that the instructions that execute on the computer or other programmable data processing apparatus create a special purpose computer for implementing the functions specified in the flowchart block or blocks. These computer program instructions may also be stored in a computer-readable memory that may direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, may be implemented by either special purpose hardware-based computer systems which perform the specified functions or steps, or suitable combinations of special purpose hardware and computer instructions.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. It should be appreciated that in the appended claims, reference to an element in the singular is not intended to mean “one and only one” unless explicitly so stated, but rather “one or more.”

Although illustrative embodiments of the present disclosure have been described herein with reference to the accompanying drawings, it is to be understood that the present disclosure is not limited to those precise embodiments, and that various other changes and modifications may be made by one skilled in the art without departing from the scope or spirit of the disclosure.

1. A system for collecting and processing data to improve sailing performance of a vessel comprising:
data acquisition devices capturing real-time data including a measured wind speed, a measured vessel velocity, a measured vessel heading, and a measured water speed;
a real-time process receiving the real-time data from the data acquisition devices, the real-time process processing the real-time data and calibration parameters to determine true wind and true current;
a calibration process receiving the real-time data from the real-time process, the calibration process processing the real-time data to produce historic vessel data correlated with timestamps, the calibration process processing the historic vessel data to generate the calibration parameters, the processing of the historic vessel data involving more historic vessel data each time the calibration parameters are generated; and
a long-term database including the historic vessel data from the calibration process, the amount of historic vessel data included in the long-term database increasing as real-time data is captured by the data acquisition devices.

2. The system of claim 1 wherein the calibration process processes the historic vessel data to generate target speed tables.

3. The system of claim 2 wherein the real-time process (106, 126; 406) determines vessel performance using the target speed tables.

4. The system of claim 1 wherein the calibration process splits the historic vessel data into tiles with defined geographical locations and scales.

5. The system of claim 1 wherein the historic vessel data included in the long-term database spans more than a calendar day.

6. The system of claim 1 wherein the historic vessel data included in the long-term database spans tracks and boundaries.

7. A method for collecting and processing data to improve sailing performance of a vessel comprising the steps of:
receiving real-time data from data acquisition devices, the real-time data including an apparent wind speed, a wind angle, and a vessel velocity;
storing the real-time data in a historic database as historic vessel data, the historic vessel data being correlated with timestamps, the historic vessel data further growing in magnitude as the data acquisition devices gather real-time data;
processing, at least a plurality of times, the historic vessel data to generate calibration parameters, each of the calibration parameters using at least some of the historic vessel data gathered prior to generation of each of the calibration parameters; and
processing the real-time data and the calibration parameters to generate a true wind and a true current experienced by the vessel.

8. The method of claim 7 further comprising the step of:
processing, at least a plurality of times, the historic vessel data to generate speed tables.

9. The method of claim 8 further comprising the step of:
processing the real-time data and the speed tables to determine vessel performance.

10. The method of claim 7 wherein the generation of each subsequent calibration parameter uses more historic vessel data than each preceding calibration parameter.

11. The method of claim 7 wherein the historic vessel data within the historic database spans at least a calendar week.

12. A device for collecting and processing data to improve sailing performance of a vessel comprising:
a process receiving real-time data from data acquisition devices, the process processing the real-time data and historic vessel data to generate calibration parameters and target speed tables, the process further processing the real-time data and the calibration parameters to determine true wind and true current experienced by the vessel, the process processing the real-time data and the target speed tables to determine vessel performance; and
a memory coupled to the process and including a database storing the historic vessel data, the historic vessel data growing in magnitude as the data acquisition devices gather real-time data, the historic vessel data and real-time data including apparent wind speed, wind angle, and vessel velocity.

13. The device of claim 12 wherein generation of a subsequent calibration parameter uses more historic vessel data than generation of a preceding calibration parameter.

14. The device of claim 12 wherein the historic vessel data is correlated with timestamps.

15. The device of claim 12 wherein the historic vessel data includes velocity made good values sorted into bins.

16. The device of claim 15 wherein each of the bins includes a range of true wind speed values.

17. The device of claim 15 wherein an overall velocity made good value of each of the bins is determined at the eightieth (80th) percentile of the velocity made good values within each of the bins.

18. The device of claim 12 wherein the process processes the historic vessel data to determine maneuvers.

19. The device of claim 18 wherein the process generates the calibration parameters by minimizing a sum of wind differences over the maneuvers when measured wind values prior to a maneuver and after a maneuver are not equal.
